(19) United States
(12) Patent Application Publication
(10) Pub. No.: US 2010/0047549 A1
(43) Pub. Date: Feb. 25, 2010

(54) Ballistic Material with Enhanced Polymer Matrix and Method for Production Thereof

(75) Inventors: Percy N. Funchess, III, Orlando, FL (US); Leslie D. Kramer, Orlando, FL (US); Valerie R. Binetti, Havertown, PA (US); Frederick J. Herman, Fort Worth, TX (US)

Correspondence Address: BUCHANAN, INGERSOLL & ROONEY PC, POST OFFICE BOX 1404, ALEXANDRIA, VA, 22313-1404, US

(73) Assignee: Lockheed Martin Corporation, Bethesda, MD (US)

(21) Appl. No.: 12/544,925

(22) Filed: Aug. 20, 2009

Related U.S. Application Data
(60) Provisional application No. 61/136,228, filed on Aug. 20, 2008.

(51) Int. Cl. B32B 27/04; B05D 3/02

(52) U.S. Cl. 428/297.4; 427/389.9

(57) ABSTRACT

A ballastic material is disclosed which contains a fibrous reinforcement; and a polymer matrix enhanced by multi-wall nanotubes, single-wall nanotubes and combinations of these. The fibrous reinforcement is impregnated with the enhanced polymer matrix.

### FIELD OF THE DISCLOSURE

A material with an enhanced polymer matrix and method of production are disclosed herein.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

The following patent documents disclose composite materials including, for example, carbon nanotubes: U.S. Pat. No. 7,041,372 to Rhoads et al.; U.S. Pub. No. 2005/0158551 A1 to Rhoads et al.; U.S. Pub. No. 2004/0097360 A1 to Benitsch et al.; U.S. Pub. No. 2003/0133865 A1 to Smalley et al.; U.S. Pub. No. 2003/0083421 A1 to Kumar et al.; U.S. Pub. No. 2002/0192142 A1 to Tillotson et al.; U.S. Pub. No. 2004/0247808 A1 to Cooper et al.; U.S. Pub. No. 2007/0082197 A1 to Ko et al.; U.S. Pub. No. 2005/0188831 A1 to Squires et al.; U.S. Pub. No. 2006/0175581 A1 to Douglas; and U.S. Pat. No. 6,478,994 to Sneddon et al., the content of each of which is hereby incorporated by reference in its entirety.

Of the foregoing, U.S. Pat. No. 7,041,372 (Rhoades et al) is commonly assigned to Lockheed Martin Corporation, and discloses anti-ballistic nanotube structures wherein single wall nanotubes are used, the content of which is hereby incorporated by reference in its entirety.

U.S. Patent Publication US 2005/0188831 (Squires et al) discloses a ballistic resistant turret for use on a vehicle, and discloses carbon nanofibers or nanotubes and woven material comprising polymeric nanofibers, the content of which is hereby incorporated by reference in its entirety.

However, a need still exists in the art for composite materials with enhanced ballistic performance.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

### SUMMARY

The present invention may address one or more of the problems and deficiencies of the prior art discussed above. However, it is contemplated that the invention may prove useful in addressing other problems and deficiencies, or provide benefits and advantages, in a number of technical areas. Therefore the claimed invention should not necessarily be construed as limited to addressing any of the particular problems or deficiencies discussed herein.

Exemplary embodiments are directed to a material comprising: a fibrous reinforcement and a polymer matrix enhanced by multi-wall carbon nanotubes, wherein the fibrous reinforcement is impregnated with the polymer matrix.

Other exemplary embodiments are directed to a material comprising: a fibrous reinforcement and a polymer matrix comprising single-wall nanotubes. The fibrous reinforcement is impregnated with the polymer matrix.

Exemplary embodiments are directed to a method for forming a material comprising: treating multi-wall carbon nanotubes to form treated multi-wall carbon nanotubes with improved adhesion to a polymer matrix; and impregnating a fibrous reinforcement with the polymer matrix, wherein the polymer matrix has been enhanced by the treated multi-wall carbon nanotubes.

### BRIEF DESCRIPTION OF THE DRAWINGS

FIG. 1 is a schematic cross-sectional illustration of a polymer matrix enhanced with nanotubes according to the present invention.

FIG. 2 is a cross-sectional view of a hybrid armor design of the present invention incorporating the ballistic material of FIG. 1.

### DETAILED DESCRIPTION

Provided is a ballistic material having an enhanced polymer matrix. A ballistic material comprises, consists of or consists essentially of a fibrous reinforcement and an enhanced polymer matrix. The material disclosed can be configured as a composite material that includes a fibrous reinforcement, such as high strength ballistic fibers including, but not limited to aramid fibers, such as Kevlar® available from Dupont, Ultra-High Molecular Weight Poly-ethylene such as Spectra® Fiber available from Honeywell or Dyneema® from DSM or other suitable, commonly available ballistic fibers. Fabrics made from high tensile strength ballistic resistant polymeric fibers can be used in ballistic materials to provide high energy absorption. In addition, ballistic materials incorporating such fibrous reinforcements are lightweight. Thus, the ballistic materials are suitable for use in personal body armor.

One embodiment, the fibrous reinforcement comprises a yarn having a denier of about 1,100 to about 1,800. For example, suitable yarns include Kevlar® style 5722 having a plain weave, warp and fill yarns of about 1420 denier, count (Ends X Picks (in)) of about 22×22, a weight of about 8.2 oz/yd², a breaking strength (lb/in) in the warp direction of about 970 lb/in, a breaking strength in the fill direction of about 960 lb/in, a thickness of about 0.0150 inches and available in a roll length of about 100 yards. The yarn can be chosen based on the threat level facing the material being produced. Any ballistic material can be enhanced by impregnation with the polymer matrix including nanotubes as described herein.

The fibrous reinforcement can be impregnated with a nanotube enhanced polymer matrix comprising, consisting of or consisting essentially of a polymer and single wall nanotubes, multi-wall nanotubes or combinations of single wall nanotubes and multi-wall nanotubes. The polymer may comprise polyurethane, epoxy, silicone and combinations thereof. The polymer matrix can be a resin.

According to certain embodiments, the polymer matrix is enhanced by single wall nanotubes (SWNT), multi-wall nanotubes (MWNT) or combinations of single wall nanotubes and multi-wall nanotubes. Carbon nanotubes have about 100 times the tensile strength of steel and a sixth of the weight of steel, making carbon nanotubes particularly suitable for use in ballistic materials. The nanotubes can be obtained from conventional processes. Suitable carbon nanotubes can be produced via laser vaporization, gas phase techniques and/or electric arc techniques. Other suitable nanotubes include silicon nanotubes and/or boron nanotubes. The silicon and/or boron nanotubes can be single wall nanotubes, multi-wall nanotubes, or combinations thereof.

As used herein, the term “nanotubes” describes fibers, tubes, and particles having a diameter of less than about 1,000 nanometers (nm). Nanotubes of the present invention may optionally have a diameter of about 10 nm to about 150 nm. The length of the nanotubes can be many times greater than the diameter thereof. Suitable nanotubes may optionally have a length of about 1 micron to about 100 microns.

The fibrous reinforcement can be impregnated with the polymer matrix comprising the SWNT, MWNT or combinations of SWNT and MWNT. In a preferred embodiment, the polymer matrix comprises, consists of or consists essentially of MWNT. Those skilled in the art will appreciate that the polymer matrix can be impregnated into any fibrous reinforcement such as those previously mentioned herein (e.g., E-glass fibers) to provide a ballistic material having enhanced strength.

The concentration of nanotubes in the polymer matrix can range from about 1.5 weight % to about 5.0 weight % (e.g., about 2 weight % to about 4.5 weight %, about 2.5 weight % to about 4.0 weight % or about 3.0 weight % to about 3.5 weight %). Also, the ballistic material contains about 40 volume % to about 70 volume % fibrous reinforcement and about 60 volume % to about 30 volume % resin (polymer matrix). The fibrous reinforcement can be woven and/or non-woven.

In an exemplary emboidment, the fibrous reinforcement can be a Kevlar® aramid composite backing, and can be impregnated to contain a ratio of 60 volume % Kevlar® and 40 volume % resin (e.g., polyurethane), wherein the resin is formed to include 1.5 weight % of nanotubes as reinforcement. Other suitable ratios and/or volume % can be used, and will vary as a function of desired material properties. For example, the fibrous reinforcement can be impregnated to contain 70 volume % Kevlar® and 30 volume % polymer matrix or 40 volume % Kevlar® and 60 volume % polymer matrix. The amount of Kevlar® or other fibrous reinforcement and polymer resin can be varied based on the threat level for which the ballistic material being made is to be used.

An exemplary method for forming a material, such as a composite ballistic material is also disclosed. In an exemplary embodiment, nanotubes, such as single wall and/or multi-wall carbon nanotubes are optionally treated to reduce the tendency of the nanotubes to agglomerate, and/or improve adhesion to the polymer. One exemplary treatment is a process disclosed in, for example, U.S. Pat. No. 6,887,450 (Chen), the disclosure of which is hereby incorporated by reference in its entirety. This process can improve the subsequent adhesion of the nanotubes to the matrix. However, methods other than that disclosed in U.S. Pat. No. 6,887,450 can be used including, but not limited to, acid treated functionalization, sonication, mechanical dispersion, or other known techniques to improve the adhesion of the nanotubes to the matrix.

As described above, the MWNT and/or SWNT can be funcitonalized. However, in some embodiments, the MWNT and/or SWNT are not functionalized. Functionalized nanotubes do not stick together and/or adhere to the polymer matrix better thereby aiding in dispersion of the nanotubes in the polymer matrix.

Optionally, multi-wall and/or single wall nanotubes which have been treated as disclosed above, can be mixed into a polymer matrix such as polyurethane resin, or other suitable material. The MWNT and/or SWNT can be substantially uniformly dispersed throughout the polymer matrix. In other embodiments, the MWNT and/or SWNT are not substantially uniformly dispersed in the polymer matrix, such that some portions of the polymer matrix include a higher concentration of MWNT and/or SWNT than other portions of the polymer matrix. For example, the concentration of MWNT and/or SWNT may decrease at the front/impact face and increase toward the back of the ballistic material so as to attenuate the shock wave caused by impact of a projectile.

In one embodiment, the MWNT and/or SWNT can be first dispersed in a solvent and then mixed with the polymer matrix to more uniformly disperse the MWNT and/or SWNT in the polymer matrix. The resultant mixture can be impregnated into a fibrous reinforcement in any known fashion to form a material as already described.

In one embodiment, the polymer matrix can be cured. Curing conditions depend on the type of polymer used. For example, polymer matrices comprising, consisting of or consisting essentially of epoxies can be cured, for example, by heating to 250° F. and holding the temperature for about 1 hour.

As formed, the laminates are multi-ply materials having about 10 to hundreds of layers of composite material depending on the threat level for which the material will be used. For example, the laminate can include fiberglass, the ballstic material enhanced with polymer matrix as described herein and ceramic material. Alternatively, the laminate can include multiple layers of the ballisitic material enhanced with polymer matrix.

Preferred ballistic materials improve performance (i.e. reduce areal weight) of armor systems against ballistic threats as compared to standard ballistic composites that lack polymer matrices including MWNT and/or SWNT.

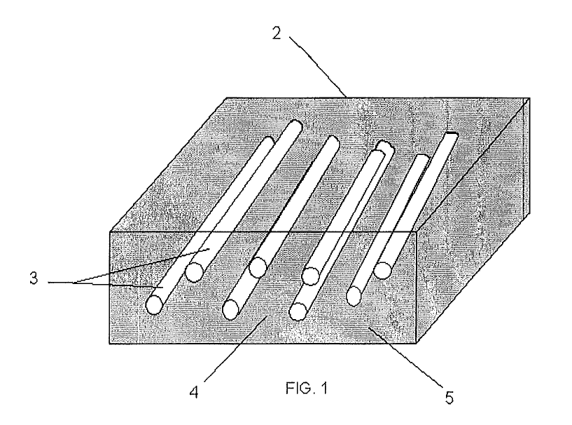

FIG. 1 is a schematic cross-sectional view of an exemplary ballistic material 2 containing a fibrous reinforcement 3 impregnated with a polymer 4 (e.g., resin) matrix that has been enhanced (i.e., reinforced) by MWNT and/or SWNT 5, such as multi-wall and/or single wall carbon nanotubes (CNT's).

The ballistic material with enhanced polymer matrix is a high strength material with strain properties sufficient to withstand impact similar to or better than current ballistic materials. The ballistic material with enhanced polymer matrix provides favorable mass efficiency as compared to traditional ballistic materials. The areal weight of the ballistic material enhanced with polymer matrix can also depend on the threat the ballistic material is trying to stop.

In use, the ballistic material with enhanced polymer matrix can be incorporated in, for example, armored vehicles, aircraft, ships, personal body armor and the like for protecting against the impact of a projectile, such as a bullet or shrapnel.

According to the present invention, the nanotubes provide significant additional toughness to the polymer matrix providing dramatically improved ballistic performance. Tested performance has shown about a 25% to about 50% improvement in residual velocity of armor piercing threats when composite panel was incorporated into an armor system.

For example, functionalized carbon nanotubes, well dispersed in a polymer matrix material, are used in conjunction with ballistic fibers to form a composite panel of the present invention having about 20 to about 50% higher ballistic performance than traditional ballastic materials.

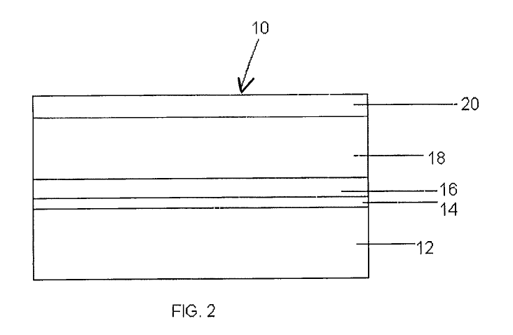

FIG. 2 is a schematic cross-sectional view of a hybrid armor design including ballistic material with enhanced polymer matrix of the present invention. It is expected that this improved design will provide weight savings of up to about 20% over traditional high performance hybrid armor systems.

As shown, the hybrid armor design 10 comprises, consists of, or consists essentially of a nanotube reinforced polymer matrix composite (PMC) 12, optionally having a thickness of about 0.250 inch, and including the fibrous reinforcement and polymer matrix including nanotubes, as described herein. The nanotube reinforced polymer matrix composite (PMC) 12 is adjacent a layer of shock attenuating adhesive 14. In one embodiment, the shock attenuating adhesive 14 is a polysulfide adhesive layer, optionally having a thickness of about 0.005 to 0.0010 inch. The shock attenuating adhesive 14 abuts a first composite restraining layer 16, which can be a carbon-epoxy composite, optionally having a thickness of about 0.008 inch. A ceramic blunting layer 18, which can be boron carbide, is sandwiched between the first composite restraining layer 16 and a second composite restraining layer 20, which can also be a carbon-epoxy composite, to form the improved ballistic material with enhanced polymer matrix 5. In an exemplary embodiment, the ceramic blunting layer 18 can have a thickness of about 0.250 inch, while the second composite restraining layer 20 can have a thickness of about 0.008 inch.

Table 1 shows velocity reduction data for various ballistic materials including Kevlar® alone and carbon nanotubes (CNT) with Kevlar®. The CNT termination plates were formed as described in Example 1 below. Comparative baseline termination plates including Kevlar were formed using a traditional polymer matrix that was not enhanced with MWNT and/or SWNT. Table 1 includes the results of ballistic testing performed at the United States Test Lab in Wichita, Kans. in accordance with MIL-STD-662 circa 2006 and/or 2007 (7.62 APM2 round at ˜2900 feet per second (fps)), the purpose of which is to provide general guidelines for procedures, equipment, physical conditions, and terminology for determining the ballistic resistance of metallic, non-metallic and composite armor against small arms projectiles. The test procedure determines the V50 ballistic limit of armor.

TABLE 1

| | Strike | Termination | Velocity | Areal | Average Velocity | Average Areal |
|---|---|---|---|---|---|---|
| | Face | Plate | Reduction (fps) | Weight (psf) | Reduction (fps) | Weight (psf) |
| Test 3 | Alumina | Kevlar ® without | 974 | 7.13 | 1184 | 7.1 |
| | | MWNT and/or SWNT | 892 | 7.1 | | |
| | | | 1684 | 7.08 | | |
| Test 3 | Alumina | CNT Kevlar ® | 1879 | 7.39 | 1623 | 7.44 |
| | | | 1465 | 7.24 | | |
| | | | 1525 | 7.69 | | |
| Test 4 | Excera | Kevlar ® without | 1381 | 6.19 | 1277 | 6.21 |
| | | MWNT and/or SWNT | 1172 | 6.22 | | |
| Test 4 | Excera | CNT Kevlar ® | 2205 | 6.46 | 2201 | 6.46 |
| | | | 2255 | 6.41 | | |
| | | | 2143 | 6.52 | | |
| Test 5 | CNT | Kevlar ® without | 680 | 5.56 | 637 | 5.57 |
| | B4C | MWNT and/or SWNT | 593 | 5.58 | | |
| Test 5 | CNT | CNT Kevlar ® | 1129 | 5.53 | 1838 | 5.63 |
| | B4C | | 2546 | 5.73 | | |
| Test 5 | Alumina | Kevlar ® without | 1731 | 7.33 | 1515 | 7.33 |
| | | MWNT and/or SWNT | 1299 | 7.33 | | |
| Test 5 | Alumina | CNT Kevlar ® | 2337 | 7.67 | 1990 | 7.64 |
| | | | 1644 | 7.60 | | |

Table 1 shows test data collected by demonstrating that with identical constructions, the termination plates that include a ballistic material enhanced with polymer matrix including SWNT showed considerable improvement in velocity reduction as compared to constructions including termination plates without a polymer matrix including SWNT.

The following illustrative, non-limiting example describes a particular embodiment of the ballistic material with enhanced polymer matrix and methods for production thereof. Exemplary material combinations are described below. The properties of the individual materials are determined from samples of the ballistic materials. For example, a 6″ by 6″ panel of ballistic material enhanced with polymer matrix can be made as follows.

### Example 1

To form 6 inch by 6 inch panels of ballistic material enhance with polymer, Kevlar® plies are first measured and cut from the roll in a 0/90 pattern. The Kevlar® used can be similar to Hexcel 722 or 720, with a areal density of about 0.290 kg/m² and made from Kevlar® 129 fiber. The plies are weighed and counted to be sure that 29 plies of fabric are used in each panel, which weighs close to 185 g. Preferably, the plies are weighed before being counted. Next, the resin (polymer matrix) is prepared by placing Kentera functionalized Nanotubes having a weight of about 4 grams into a 330 mL chloroform solution by High Shear Mixing at about 5000 rpm for about 5 minutes. Once mixed, about 80 grams of Air Products Airthane PHP-70A is added to the solution and mixed by HSM at about 5000 rpm for about 2 minutes. Once received from Air Products, the PHP-70A prepolymer is broken down into smaller containers for use as individual batches. These batches, when needed, are heated to about 60° C. to make the prepolymer less viscous and easier to measure. After each of the small batches has been brought to temperature 4 times, it is discarded to prevent damage to the prepolymer. Before the panel is laid up, the curing agent is added. For the single panel batch, about 3.82 grams of Lonzacuree is dissolved in about 20 mL of chloroform. This solution is added to the carbon nanotube/chloroform/prepolymer solution and mixed by hand. In a larger batch, for making ten 6 inch by 6 inch panels, this step is done with HSM at a lower speed of about 2000 rpm for about 3 minutes. When doing a ten panel batch of resin, the entire batch is made at once, and the panels are all made from the same batch of resin. This could pose problems of solvent flash off for the later panels, which may make them better in the long run, but may alter the resin content of the panels made towards the end of the process and may make processing of the resin more difficult with the latter panels. The panels are then laid up on flat metal sheets covered with a mold-release film. Before the first ply is laid down, the tool is covered with resin using a paint brush. The amount of resin per ply is determined by taking the weight of the total resin batch, dividing by the number of plies, and weighing out the appropriate amount of resin before the first ply is laid up. Once the first ply is measured out, the level of resin in the plastic measuring cup is marked and each subsequent ply is measured to make sure that roughly the same amount of resin goes on between plies. After both sides of the ply are covered with resin, the next ply is laid down, and rolled with a metal roller to squeeze out some air and ensure adhesion. Then the resin is painted on top. Once the last ply is laid up and resin is applied thereto, an upper plate of the tooling is laid over the panel. Next the material undergoes a cure/press cycle. The temperature controllers are set to about 176° F., and the tool is inserted onto the platen. A Pull −29 in Hg vacuum is on part to assist in solvent flash off. No pressure is applied by the press at this point. After about 30 minutes of degassing, platens are raised into contact. Pressure is applied until the gauge reads about 12000 lb loading. Vacuum and a temperature of about 176° F. is maintained at this pressure for about 30 minutes. The load is then increased to about 28100 lbs and held for about 60 minutes, at which point the vacuum pump can be turned off. About 28100 lbs gives a pressure of about 780.5 psi on each 6 inch by 6 inch panel. At this point, temperature of the platens can be raised to about 250° F., and the 28100 load can be maintained for about 120 minutes more. Once finished, the machine can be opened and the panels allowed to cool to room temperature. Upon demolding from the tool, the surfaces of the panels may be repainted with resin if the release film sticks to the surface and damages the panels. The panels are not subjected to a full cure afterwards.

In some embodiments, post cure of the panels can occur. The Lonzacure® material does not begin to melt until about 80° C., so when curing and using this material, the cure is recommended to be carried out at about 100° C. and above. Preferably, the cure time at 100° C. is about 16 hours. The pot life of the material at a 95% stoichiometry is about 20 minutes.

All numbers expressing quantities or parameters used in the specification are to be understood as additionally being modified in all instances by the term “about.” Notwithstanding the numerical ranges and parameters set forth, the broad scope of the subject matter presented herein are approximations, the numerical values set forth are indicated as precisely as possible. For example, any numerical value may inherently contain certain errors resulting from inaccuracies in their respective measurement techniques, or round-off errors and other common inaccuracies.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

We claim:

1. A ballistic material comprising:
a fibrous reinforcement; and
a polymer matrix comprising multi-wall nanotubes,
wherein the fibrous reinforcement is impregnated with the polymer matrix.

2. A ballistic material according to claim 1, wherein the fibrous reinforcement comprises aramid fibers.

3. A ballistic material according to claim 1, wherein the fibrous reinforcement comprises E-glass fibers.

4. A composite ballistic material according to claim 1, wherein the fibrous reinforcement comprises ultra-high molecular weight poly-ethylene fibers.

5. A ballistic material according to claim 1, wherein the polymer matrix comprises an epoxy.

6. A ballistic material according to claim 1, wherein the polymer matrix comprises a polyurethane.

7. A ballistic material according to claim 1, wherein the polymer matrix comprises a silicone.

8. A ballistic material according to claim 1, wherein the multi-wall nanotubes are included in an amount of about 1.5 weight % to about 5 weight %

9. A ballistic material according to claim 1, wherein the fibrous reinforcement comprises yarn having a denier of about 1100 to about 1800.

10. A ballistic material according to claim 1, wherein the multi-wall nanotubes comprise multi-wall carbon nanotubes, multi-wall boron nanotubes, multi-wall silicon nanotubes, or combinations thereof.

11. A ballistic material according to claim 1, wherein the ballistic material comprises about 40 volume % to about 70 volume % of the fibrous reinforcement.

12. A ballistic material according to claim 1, wherein the ballistic material comprises about 60 volume % to about 30 volume % of the polymer matrix.

13. A ballistic material according to claim 1, wherein the ballistic material comprises about 60 volume % aramid fibers and about 40 volume % polyurethane resin.

14. A ballistic material according to claim 13, wherein the polyurethane resin comprises about 1.5 weight % multi-wall nanotubes.

15. A method for forming a ballistic material comprising:
treating multi-wall carbon nanotubes to form functionalized multi-wall carbon nanotubes with improved adhesion to a polymer matrix;
adding about 1.5 weight % to about 5 weight % functionalized multi-wall carbon nanotubes to the polymer matrix; and
impregnating a fibrous reinforcement with the polymer matrix, wherein the polymer matrix has been enhanced by the functionalized multi-wall carbon nanotubes.

16. The method of claim 15, wherein the method further comprises curing the impregnated fibrous reinforcement.

17. A ballistic material comprising:
a fibrous reinforcement; and
a polymer matrix comprising single-wall nanotubes,
wherein the fibrous reinforcement is impregnated with the polymer matrix.

18. The ballistic material according to claim 17, wherein the polymer matrix further comprises multi-wall nanotubes.

19. A ballistic material according to claim 17, wherein the single-wall nanotubes are selected from the group consisting of single-wall carbon nanotubes, single-wall boron nanotubes, single-wall silicon nanotubes and combinations thereof.

20. A ballistic material according to claim 17, wherein the fibrous reinforcement comprises aramid fibers and the polymer matrix comprises polyurethane resin.
